(19) United States
(12) Patent Application Publication
(10) Pub. No.: US 2014/0032735 A1
(43) Pub. Date: Jan. 30, 2014

(54) ADAPTIVE RATE OF SCREEN CAPTURE IN SCREEN SHARING

(71) Applicant: Abhinav Kapoor, Fremont, CA (US)

(72) Inventor: Abhinav Kapoor, Fremont, CA (US)

(21) Appl. No.: 12/140,855

(22) Filed: Jun. 17, 2008

(51) Int. Cl. G06F 15/16

(52) U.S. Cl. 709/224

(57) ABSTRACT

A method of sharing a display with another computing device is provided. Here, a rate of screenshot capture may be adjusted in reference to a variety of different parameters. For example, the rate may be adjusted in reference to a usage of a processor. In another example, the rate may be adjusted in reference to a compression ratio. The screenshots captured at the adjusted rate are then transmitted to another computing device.

### FIELD

The present disclosure relates generally to network conferencing. In one example embodiment, the disclosure relates to adaptive rate of screenshot capture in screen sharing.

### BACKGROUND

Network conferencing refers to interactive communication technologies that allow participants at two or more locations to interact. Such network conferencing may be achieved, for example, by way of real-time two-way video and audio transmissions. In a network conference, a participant may communicate and share data with other participants. For example, a participant can transmit images or contents rendered on his video display to other participants in the network conference. Such sharing of display is referred to as screen sharing. With screen sharing, participants within the network conference may see the display or screen viewed by other participants.

It should be appreciated that screen sharing can be computationally intensive and requires a large amount of processor resources. As a result, screen sharing during a network conference can adversely affect the performance of other applications executing on the same computing device that is processing the screen sharing. Furthermore, the transmission of data used in screen sharing may require a large amount of network bandwidth, which may further delay the transmission of other data.

### BRIEF DESCRIPTION OF DRAWINGS

The present disclosure is illustrated by way of example and not limitation in the figures of the accompanying drawings, in which like references indicate similar elements and in which:

FIG. 1 is a diagram depicting a network conference system, in accordance with an example embodiment;

FIG. 2 is a block diagram of a network conference module hosted on computing device, in accordance with an example embodiment;

FIG. 3 depicts a flow diagram of a general overview of a method, in accordance with an example embodiment, for adjusting a rate of screenshot capture in reference to a usage of a processor;

FIG. 4 depicts a flow diagram of a detailed method, in accordance with an example embodiment, for adjusting the rate of screenshot capture in reference to a usage of the processor;

FIG. 5 depicts a flow diagram of a general overview of a method, in accordance with an example embodiment, for adjusting a rate of screenshot capture in reference to a compression ratio;

FIG. 6 depicts a graph diagram illustrating a plot of reduced file sizes after compression, in accordance with an example embodiment;

FIG. 7 depicts a flow diagram of a detailed method, in accordance with an example embodiment, for adjusting a rate of screenshot capture in reference to a compression ratio; and

FIG. 8 is a block diagram of a machine in the example form of a computing device within which a set of instructions, for causing the machine to perform any one or more of the methodologies discussed herein, may be executed.

### DESCRIPTION OF EXAMPLE EMBODIMENTS

In the following description, for purposes of explanation, numerous specific details are set forth in order to provide a thorough understanding of an example embodiment of the present disclosure. It will be evident, however, to one skilled in the art that the present disclosure may be practiced without these specific details.

The example embodiments described herein provide various techniques for adjusting a rate of screenshot capture used in screen sharing. In general, this rate of screenshot capture corresponds to a frame rate at which the display is animated. The rate of screenshot capture may be adjusted in reference to a variety of different parameters. For example, as explained in more detail below, the rate may be adjusted in reference to a usage of a processor. In another example, as explained in more detail below, the rate may be adjusted in reference to a compression ratio. As a result, the rate of screenshot capture is not constant and is instead, adaptive to various fluctuating parameters, such as usage of a processor and compression ratio.

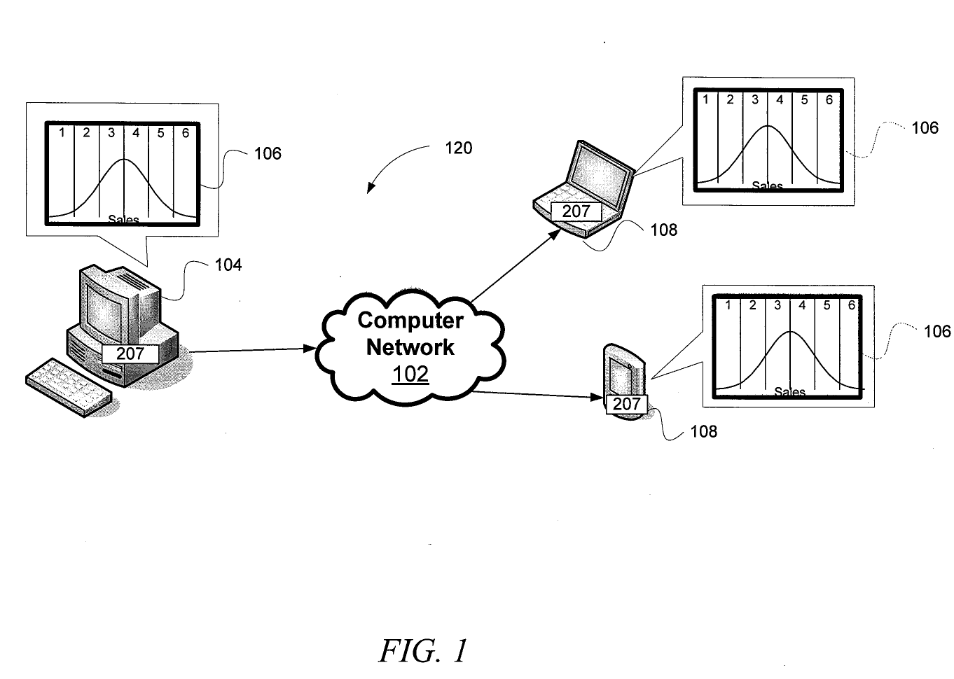

FIG. 1 is a diagram depicting a network conference system 120, in accordance with an example embodiment. As shown in FIG. 1, the network conference system 120 includes endpoint 104 in communication with endpoints 108. Endpoints 104 and 108 may be in communication through a computer network 102 (e.g., local area network (LAN), Wide area network (WAN), Internet or other computer networks) or through other connections. In a network conference, applications associated with endpoint 104 can share or communicate data with applications associated with endpoints 108. In general, a network conference allows two or more applications associated with endpoints, such as endpoints 104 and 108, to interact and/or collaborate in real-time. An example of a network conference includes video and audio conferencing that allows, for example, an application associated with endpoint 104 to interact with applications associated with endpoints 108 by way of simultaneous two-way video and audio transmissions.

Screen sharing uses two-way video transmissions between endpoints 104 and 108 to share rendered display. As depicted in FIG. 1, a computing device associated with endpoint 104 may render a display 106. A network conference module 207 hosted on computing device 104 can share this rendered display 106 by transmitting this display 106 to endpoints 108. The computing devices associated with endpoints 108 receive display 106 from endpoint 104 renders this display. 106 on their video displays. Such screen sharing may be used in a variety of different network conferences such as multiplayer game sharing, application sharing, whiteboard conferencing, and other network conferences.

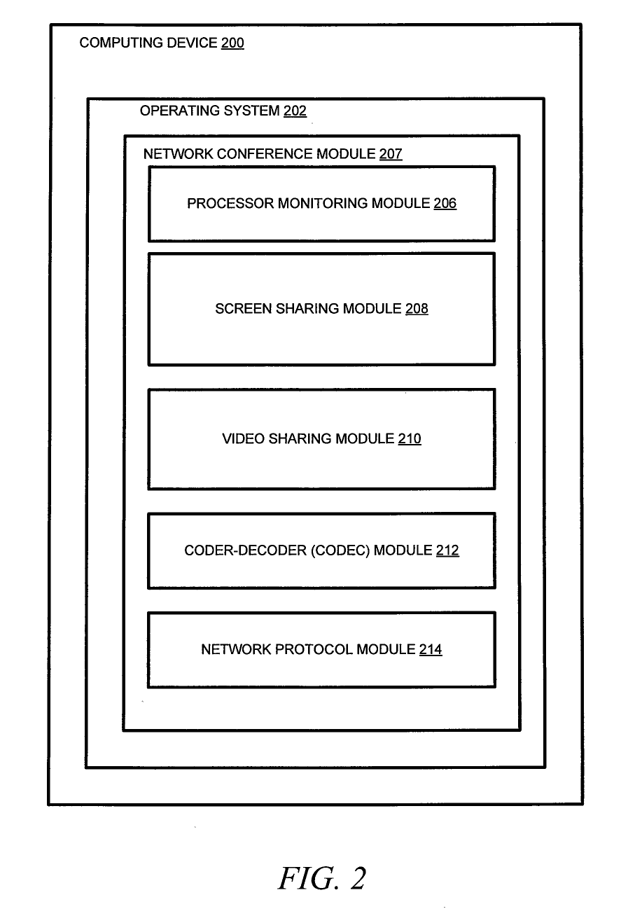

FIG. 2 is a block diagram of a network conference module 207 hosted on computing device 200, in accordance with an example embodiment. The computing device 200 includes operating system 202 that manages the software processes and/or services executing on the computing device 200. As shown in FIG. 2, these software processes and/or services may include network conference module 207. The network conference module 207 enables network conferencing on the computing device 200. For example, the network conference module 207 can facilitate the interaction and/or collaboration of two or more applications in real-time. The network conference module 207 includes processor monitoring module 206, screen sharing module 208, video sharing module 210, coder-decoder (codec) module 212, and network protocol module 214.

The processor monitoring module 206 is configured to monitor a usage of a processor. The usage indicates an amount of workload that is handled by a processor. That is, the usage may indicate the amount of resources that is used by the processor. The amount may be expressed as a percentage. For example, a load of 100% indicates that processor is fully utilized, whereas a load of 50% indicates that the processor is sitting idle half the time. To monitor the usage, the processor monitoring module 206 may itself calculate the usage. Alternatively, the processor monitoring module 206 may periodically retrieve or receive the usage from a variety of third-party applications that are configured to calculate the usage. It should be appreciated that a variety of processors may be monitored, such as central processing units (CPU), graphics processing units (GPU), and other processors.

The screen sharing module 208 is configured to capture screenshots for transmittal to other computing devices when screen sharing in a network conference. A “screenshot,” as used herein, is a reproduction or copy of a display rendered on a video display, which may be saved as a graphics file. The screen sharing module 208 captures the screenshots at a certain rate. As explained in more detail below, this screen sharing module 208 is also configured to adaptively adjust the rate of screenshot capture in reference to various parameters, such as a usage of the processor received from processor monitoring module 206 and/or a compression ratio derived from file sizes of compressed screenshots.

The video sharing module 210 is configured to interface with a video camera, and to receive video captured by the video camera. Such video may be directly transmitted to other computing devices in the network conference. Alternatively, the video may be transmitted to screen sharing module 208, which may capture the video for transmission to other computing devices. The coder-decoder (codec) module 212 is configured to encode and/or decode screenshots captured by screen sharing module 208. An example of a codec 212 is a video codec that is configured to compress and/or decompress video data. In video compression, a quantity of data used to represent video images can be reduced by image compression and motion compensation. Examples of codec module 212 include International Telecommunications Union (ITU) H.261 codec, ITU H.263 codec, MPEG-4 codec, Sorenson Video Codec, and other codecs.

The network conference module 207 may also include the network protocol module 214 that is configured to encode the compressed screenshots for transmittal over a computer network. An example of a network conference module 207 is a Transmission Control Protocol (TCP)/Internet Protocol (IP) encoder. It should be appreciated that in other example embodiments, computing device 200 may include fewer or more modules apart from those shown in FIG. 2. For example, screen sharing module 208 may be integrated into processor monitoring module 206 to form one module. Furthermore, some of the functions, such as the codec module 212 and the network protocol module 214, may be handled by the operating system 202.

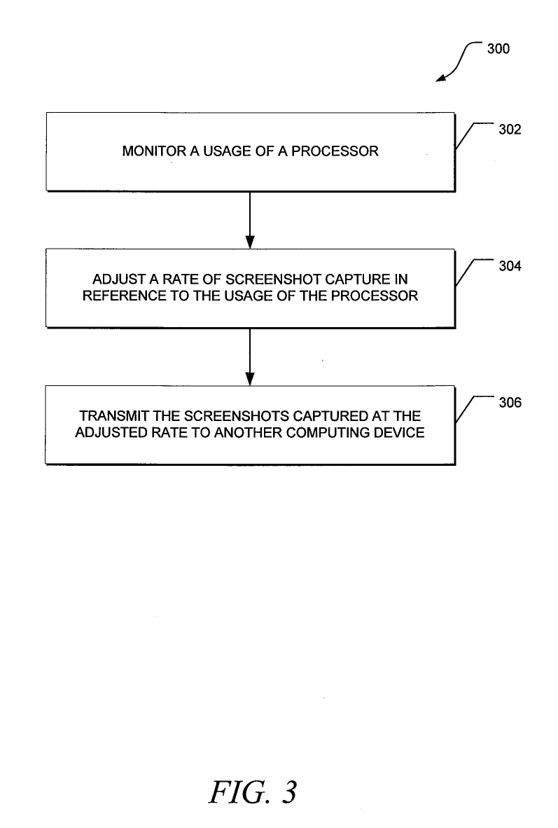

FIG. 3 depicts a flow diagram of a general overview of a method, in accordance with an example embodiment, for adjusting a rate of screenshot capture in reference to a usage of a processor. In an example embodiment, method 300 may be implemented by the network conference module 207 of FIG. 2 and employed in computing device 200.

As depicted in FIG. 3, a usage of a processor is monitored at 302, which is discussed above, and screenshots may be captured in reference to the usage of the processor. The screenshots are captured at a rate. This “rate” of screenshot capture, as used herein, is a number of screenshots captured within a time interval. For example, screenshots may be captured at a rate of 50 screenshots/second. In another example, screenshots may be captured at a rate of 30 screenshots/second. It should be noted that this rate of screenshot capture may correspond to a number of frames displayed, which is referred to as a frame rate, when shared with other computing devices. The frame rate is the number of frames of video animation or images that are displayed every second or other time interval. As an example, the frame rate may be measured in frames per second (fps). The higher the frame rate, the smoother the video will appear. The frame rate displayed by other computing devices during screen sharing cannot exceed the rate of screenshot capture. As an example, if the rate of screenshot capture is 50 screenshots/second and the screenshots captured at this rate are transmitted to other computing devices, then other computing devices may display the screenshots at a frame rate of 50 frames/second or less.

This rate of screenshot capture is adaptive and may be adjusted at 304. In an example embodiment, this rate may be adjusted in reference to the usage of the processor. That is, the number of screenshots captured within a time interval, which is the rate of screenshot capture, may be defined in reference to the usage of the processor. Adjustments may be made by adjusting the number of screenshots and/or adjusting the time interval. In an example, the rate may be increased by increasing the number of screenshot captured. Alternatively, the rate may be increased by decreasing the time interval. In another example, the rate may be decreased by decreasing the number of screenshots captured. Alternatively, the rate may be decreased by increasing the time interval.

As explained in more detail below, the rate of screenshot capture may be adjusted or defined in reference to a comparison between the usage of the processor with one or more thresholds. The screenshots are then transmitted at 306 to another computing device that is included in the network conference system.

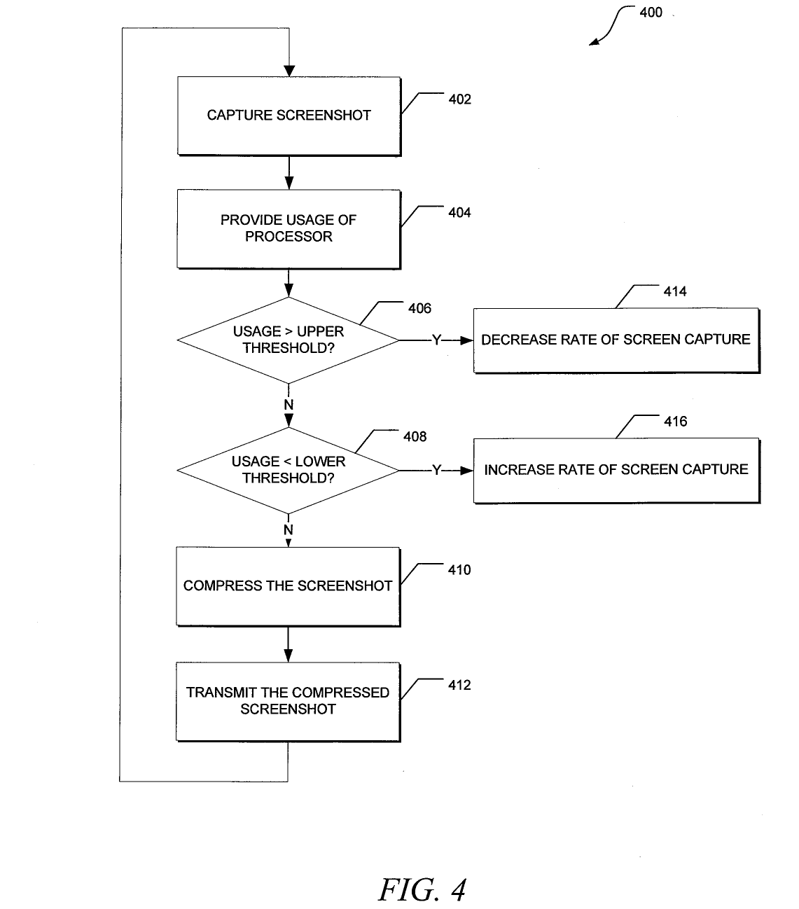

FIG. 4 depicts a flow diagram of a detailed method 400, in accordance with an example embodiment, for adjusting the rate of screenshot capture in reference to a usage of the processor. At 402, a screenshot is captured. Additionally, a usage of the processor is provided at 404. The usage of the processor is then compared to an upper threshold at 406. This upper threshold is defined relative to a usage of the processor. For example, the upper threshold may be defined as 80% of full usage. In another example, the upper threshold may be defined as 90% of full usage. If the usage exceeds the upper threshold, then the processor is heavily loaded and may not be able to handle a high rate of screenshot capture, which may take a large amount of processor resources. As a result, the rate of screenshot capture is decreased at 414. The rate of screenshot capture may be decreased in increments until a minimum rate of screenshot capture is reached. For example, the rate may be adjusted to or defined as:

New Rate=Max(Current Rate−1, Min_Rate) (1.0)

where the current rate of screenshot capture is incrementally subtracted by one screenshot with every adjustment until the minimum rate is reached.

On the other hand, if the usage does not exceed the upper threshold, then another comparison is made at 408. Here, the usage of the processor is compared to a lower threshold. This lower threshold is less than the upper threshold discussed above. An example of a lower threshold may be defined as 30% of full usage. In another example, the lower threshold may be defined as 10% of full usage. If the usage is less than or falls below the lower threshold, then the processor is not heavily loaded and may be able to handle a high rate of screenshot capture. As a result, the rate of screenshot capture is increased at 416. Similarly, the rate of screenshot capture may be increased in increments until a maximum rate of screenshot capture is reached. For example, the rate may be adjusted to or defined as:

New Rate=Min(Current Rate+1, Max_Rate) (2.0)

where the current rate of screenshot capture is incrementally added by one screenshot with every adjustment until the maximum rate is reached.

It should be appreciated that two thresholds are used in the comparison because two thresholds prevent frequent adjustments by providing a range between the upper threshold and lower threshold where adjustments are not made. However, in another example embodiment, one threshold may be used in the comparison. Here, the rate of screenshot capture is decreased if the usage exceeds this one threshold. Vice versa, the rate of screenshot captured may be increased if the usage falls below the same threshold. As a result, it should be appreciated that a comparison can be made with one or more thresholds.

Still referring to FIG. 4, the screenshot is then compressed at 410 and transmitted to another computing device at 412. In addition to comparing the usage with one or more thresholds, the rate of screenshot capture may also be adjusted in reference to other quantification or calculation based on the usage of the processor. In an example embodiment, the average usage of the processor within a certain time interval may be calculated and the usage may be adjusted in reference to this average. In another example embodiment, for the usage may be monitored over a time interval and a statistical magnitude of the usage may be calculated. The usage of the processor may be adjusted in reference to the statistical magnitude of the usage.

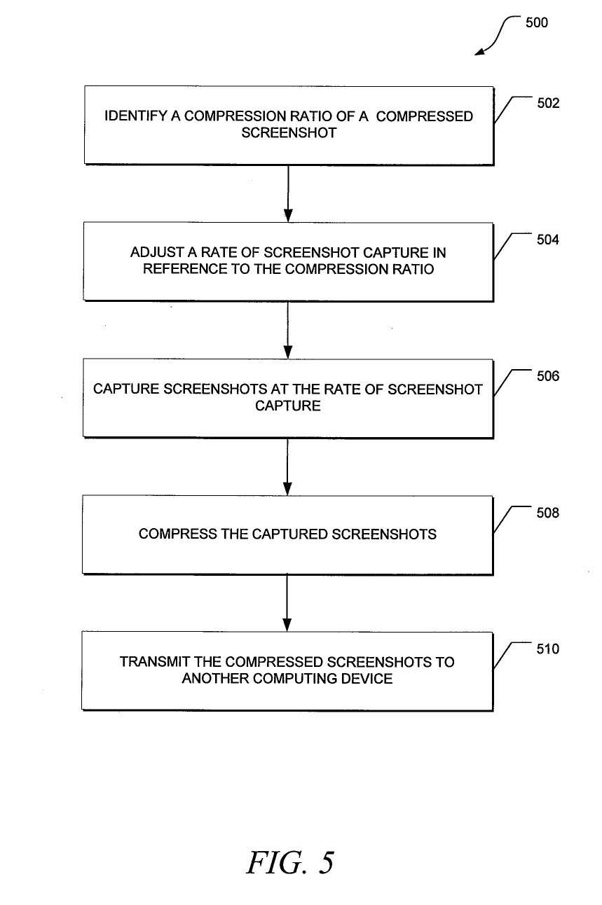

FIG. 5 depicts a flow diagram of a general overview of a method, in accordance with an example embodiment, for adjusting a rate of screenshot capture in reference to a compression ratio. In an example embodiment, method 500 may be implemented by the network conference module 207 of FIG. 2 and employed in computing device 200. As depicted in FIG. 5, a compression ratio of a compressed screenshot is identified at 502. A “compression ratio,” as used herein, is a ratio between an uncompressed file size of the captured screenshot and the reduced file size of the compressed screenshot. The compression ratio defines the compressibility of a file. The compression ratio may be identified by recording a size of the file before compression and then recording the size of the file after compression. As discussed above, a codec may compress the screenshots. In an example, the compression ratio may be the reduced file size recorded after compression divided by the uncompressed file size recorded before compression. As a result, in this example, the compression ratio may be expressed as a fraction, where a large number (e.g., 0.99, and 0.88) identifies a low compressibility of the file. A low compression ratio (e.g., 0.20, and 0.30) identifies a high compressibility of the file. That is, the file can be highly compressed. In another example, the compression ratio may be the uncompressed file size recorded before compression divided by the reduced file size recorded after compression. Here, a large number identifies a high compressibility of the file while a low number identifies a low compressibility of the file.

The rate of screenshot capture, in accordance with another example embodiment, can also be adjusted at 504 in reference to the compression ratio. As explained in more detail below, this compression ratio may identify a type of display being captured and the rate of screenshot capture may be adjusted to optimize the quality of the display being shared. Additionally, the rate of screenshot capture may be increased or decreased based on comparison with one or more thresholds, as discussed in more detail below. The screenshots may then be captured at the adjusted rate at 506 and compressed at 508. The compressed screenshots may then be transmitted to another computing device included in the network conference system at 510.

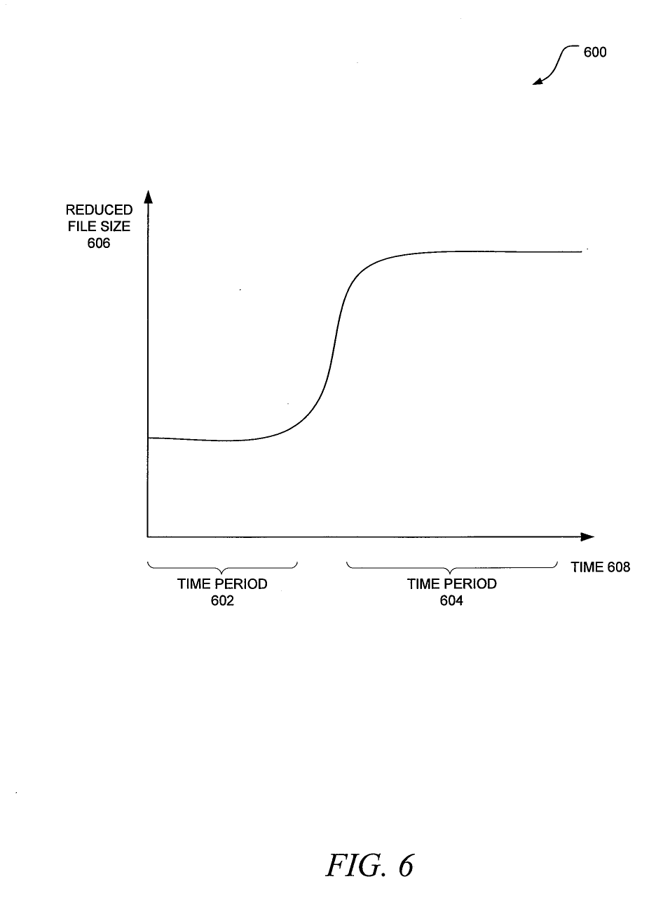

FIG. 6 depicts a graph diagram 600 illustrating a plot of reduced file sizes after compression, in accordance with an example embodiment. The graph diagram 600 includes horizontal axis 608 and vertical axis 606 at right angles to each other. The horizontal axis 608 defines time, which increases from left to right. The vertical axis 606 defines a file size of a screenshot after the screenshot is compressed (or a “reduced file size”). This reduced file size 606 increases from bottom to top along the vertical axis 606. The graph diagram 600 therefore is a plot of the output file size from a codec over a period of time.

It should be appreciated that a compression ratio may identify the type of display included in the captured screenshot. A graphical display is a type of display that is mostly comprised of images. Examples of graphical displays include displays of pictures, animation, drawings, and videos. Another example of a type of display is a text display that is mostly comprised of text. Examples of text displays include displays of documents, spreadsheets, and presentations. It should be noted that different types of displays may have different compression ratios. That is, some types of displays may be more or less compressible than other types of displays. For example, a codec specifically configured to encode video images may be able to more efficiently compress a graphical display than a text display. That is, a video codec may compress a screenshot of a graphical display into a smaller file than compared to a compression of a screenshot of a text display. The compression ratio may therefore be used to identify a type of display that is compressed. The adjustment of the rate of screenshot capture in reference to the compression ratio may therefore correspond to an adjustment in reference to the type of display being compressed. As a result, in an example embodiment, the rate of screenshot capture can be adjusted in reference to the type of display being compressed.

As depicted in FIG. 6, the graph diagram 600 shows a plot of the reduced file size holding steady during time period 602 and then drastically increasing during time period 604. With the use of a codec specifically configured to encode video, the small file sizes of the screenshots captured during time period 602 identify that the screenshots are highly compressible and therefore may correspond to a compression of screenshots that include graphical displays. The large file sizes of the screenshots captured during time period 604 identify that the screenshots are not highly compressible and therefore may correspond to a compression of screenshots that include text displays. As a result, as will be explained in more detail below, the rate of screenshot capture may be adjusted to optimize the quality of captured screenshots that are shared with other computing devices.

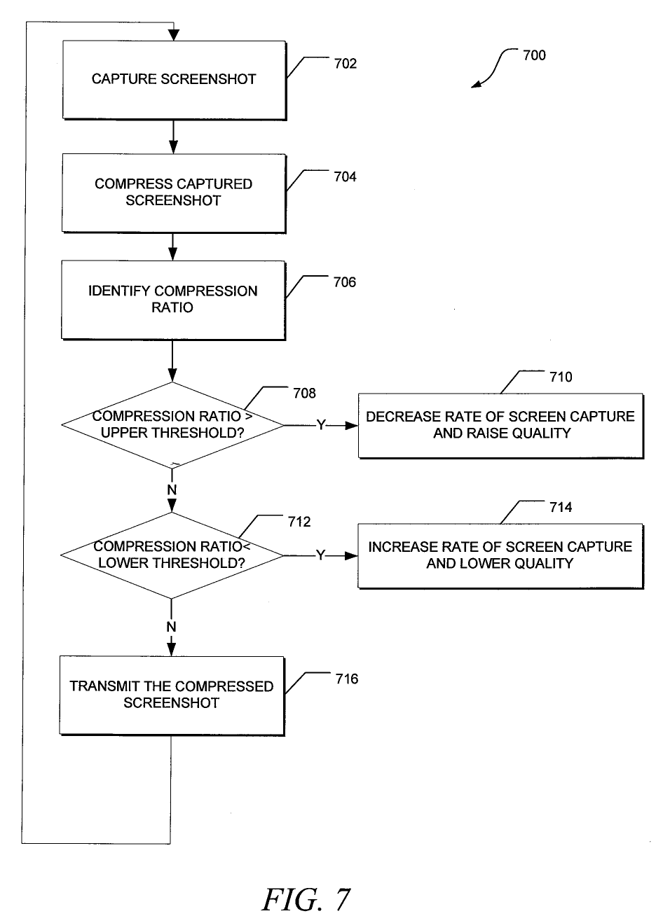

FIG. 7 depicts a flow diagram of a detailed method 700, in accordance with an example embodiment, for adjusting a rate of screenshot capture in reference to a compression ratio. As depicted in FIG. 7, a screenshot is captured at 702 and then compressed at 704. As discussed above, the compression ratio may be identified at 706 based on a file size of the screenshot captured at 702 and a reduced file size of the screenshot compressed at 704. In the example of FIG. 7, the compression ratio is defined as the reduced file size recorded after compression divided by the uncompressed file size recorded before compression.

The compression ratio is then compared to an upper threshold at 708. In this example embodiment, this upper threshold is defined relative to the compression ratio. For example, the upper threshold may be defined as 10% compressibility (or 90% incompressibility). In another example, the upper threshold may be defined as 25% compressibility (or 75% incompressibility). Since the compression ratio is the reduced file size recorded after compression divided by the uncompressed file size recorded before compression, a high compression ratio indicates that the screenshot is not highly compressible, which can identify that the screenshot is comprised mostly of text display. Therefore, if the compression ratio exceeds the upper threshold, then the rate of screenshot capture is decreased at 710 because a text display does not usually change as much as a graphical display. In an example, the rate of screenshot capture may be decreased in accordance with Equation 1.0, as defined above. With the decreased rate, the quality of the captured screenshot may be increased. That is, with less screenshots being captured, the resolution of the screenshot may be increased such that the resulting text display is sharper and clearer than a screenshot captured with a lower resolution, but at a higher rate of screenshot capture.

On the other hand, if the compression ratio does not exceed the upper threshold, then another comparison is made at 712 with a lower threshold. In this example embodiment, this lower threshold is defined relative to the compression ratio and is less than the upper threshold. For example, the lower threshold may be defined as 90% compressibility (or 10% incompressibility). In another example, the lower threshold may be defined as 75% compressibility (or 25% incompressibility). In this example, a low compression ratio indicates that the screenshot is highly compressible, which can identify that the screenshot is comprised mostly of graphical display. Therefore, if the compression ratio falls below the lower threshold, then the rate of screenshot capture is increased at 714. Again, in an example, the rate of screenshot capture may be increased in accordance with Equation 2.0, as defined above. That is, a high rate of screenshot capture can result in smoother animation shown during screen sharing, but the screenshot is captured at a lower resolution, which results in less clarity when compared with a screenshot captured at a higher resolution.

It should be noted that the comparison of the compression ratio with the upper and lower threshold depends on the convention used to define the compression ratio. As an example, this compression ratio may also be defined as the uncompressed file size recorded before compression divided by the reduced file size recorded after compression. In this example, a high compression ratio indicates that the screenshot is highly compressible while a low ratio indicates that the screenshot is not highly compressible. As a result, if the compression ratio exceeds the upper threshold, then the rate of screenshot capture is increased. On the other hand, if the compression ratio falls below the lower threshold, then the rate of screenshot capture is decreased.

Still referring to FIG. 7, the compressed screenshot is then transmitted to other computing devices within the network conference system at 716. Another screenshot is then captured and method 700 repeats such that the rate of screenshot capture is adaptively decreased or increased, which may thereby result in an increase or decrease in quality of the captured screenshot, respectively, in reference to a type of display included in the captured screenshot.

It should be appreciated that in addition to adjusting the rate of screenshot capture in reference to either the usage of the processor or the compression ratio, the rate of screenshot capture may also be adjusted in reference to a combination of the usage of the processor and the compression ratio. In an example embodiment, the compression ratio is identified and the usage of the processor is monitored. The rate of screenshot capture may then be adjusted in reference to both the compression ratio and the usage of the processor. As an example, if the usage of the processor exceeds a certain upper threshold and the compression ratio exceeds another upper threshold, then the rate of screenshot capture may be decreased. On the other hand, if the usage of the processor falls below a certain lower threshold and the compression ratio falls below another lower threshold, then the rate of screenshot capture may be increased.

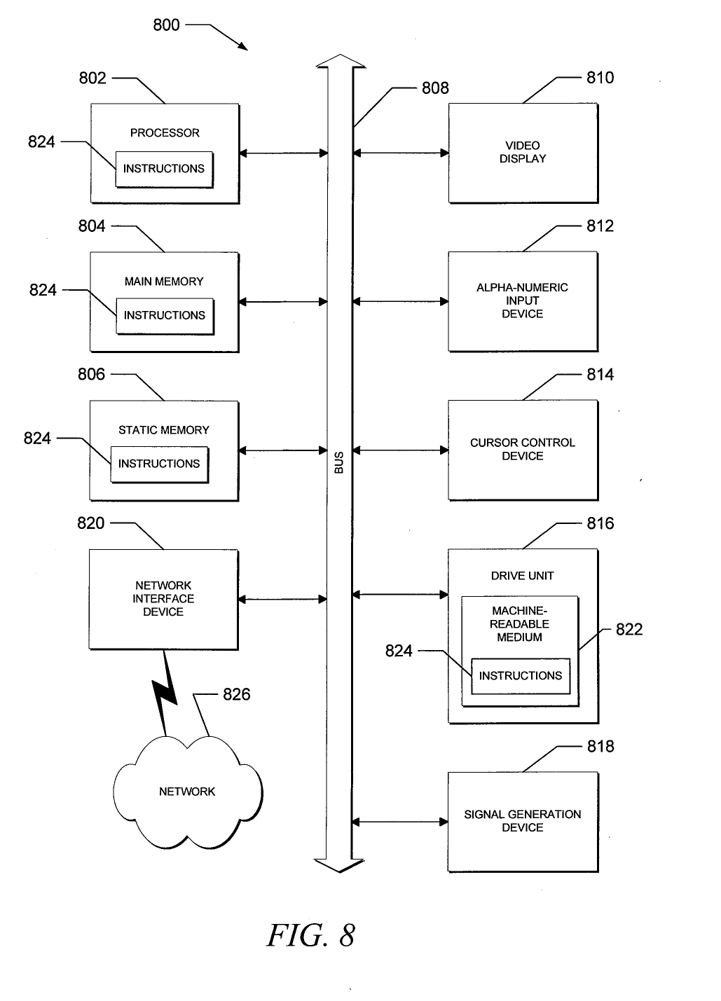

FIG. 8 is a block diagram of a machine in the example form of a computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. In a networked deployment, the machine may operate in the capacity of a server or a client machine in server-client network environment, or as a peer machine in a peer-to-peer (or distributed) network environment. Embodiments may also, for example, be deployed by Software-as-a-Service (SaaS), Application Service Provider (ASP), or utility computing providers, in addition to being sold or licensed via traditional channels. The machine may be a computer, a tablet PC, a set-top box (STB), a Personal Digital Assistant (PDA), a cellular telephone or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing device 800 includes processor 802 (e.g., a central processing unit (CPU), a graphics processing unit (GPU) or both), main memory 804 and static memory 806, which communicate with each other via bus 808. Computing device 800 may further include video display unit 810 (e.g., a plasma display, a liquid crystal display (LCD) or a cathode ray tube (CRT)). Computing device 800 also includes alphanumeric input device 812 (e.g., a keyboard), user interface (UI) navigation device 814 (e.g., a mouse), disk drive unit 816, signal generation device 818 (e.g., a speaker) and network interface device 820.

The disk drive unit 816 includes machine-readable medium 822 on which is stored one or more sets of instructions and data structures (e.g., software 824) embodying or utilized by any one or more of the methodologies or functions described herein. Software 824 may also reside, completely or at least partially, within main memory 804 and/or within processor 802 during execution thereof by computing device 800, main memory 804 and processor 802 also constituting machine-readable, tangible media.

The software 824 may further be transmitted or received over network 826 via network interface device 820 utilizing any one of a number of well-known transfer protocols (e.g., HTTP).

While machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the invention(s) is (are) described with reference to various implementations and exploitations, it will be understood that these embodiments are illustrative and that the scope of the invention(s) is not limited to them. In general, techniques for adaptively adjusting a rate of screen capture may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A method of sharing a display rendered by a first computing device having a processor, the method comprising:
monitoring a workload of the processor;
identifying a compression ratio of compressed screenshots;
adjusting a rate of screenshot capture at the first computing device based on the workload of the processor and the compression ratio, the rate defining a number of screenshots captured within a time interval, the adjustment in reference to the compression ratio being an adjustment in reference to a type of display being compressed; and
transmitting the screenshots captured at the adjusted rate of screenshot capture to a second computing device.

2. The method of claim 1, wherein the adjusting of the rate of screenshot capture comprises decreasing the rate of screenshot capture based on the workload of the processor exceeding a threshold level, the workload indicating an amount of resource that is used by the processor.

3. The method of claim 1, wherein the adjusting of the rate of screenshot capture comprises increasing the rate of screenshot capture based on to the workload of the processor falling below a threshold level, the workload indicating an amount of resource that is used by the processor.

4. The method of claim 1, further comprising capturing the screenshots at the adjusted rate of screenshot capture.

5. The method of claim 1, further comprising compressing the screenshots.

6. The method of claim 1, wherein the type of display is a text display, a picture display, or an animation display.

7. The method of claim 1, wherein the first computing device and the second computing device are included in a network conference system.

8. The method of claim 1, wherein the adjusting the rate of screenshot capture includes adjusting the number of screenshots captured.

9. The method of claim 1, wherein the adjusting the rate of screenshot capture includes adjusting the time interval.

10. A non-transitory machine-readable storage medium that stores instructions, which when performed by a machine, cause the machine to perform operations comprising:
capturing screenshots at a first computing device;
compressing the captured screenshots;
identifying a compression ratio of the compressed screenshots;
monitoring a workload of the processor of the first computing device; and
adjusting a rate of screenshot capture at the first computing device in reference to the compression ratio and the workload of the processor, the rate of screenshot capture defining a number of the screenshots captured within a time interval, the adjustment in reference to the compression ratio being an adjustment in reference to a type of display being compressed; and
transmitting the compressed screenshots to a second computing device.

11. The non-transitory machine-readable storage medium of claim 10, further comprising capturing further screenshots at the adjusted rate of screenshot capture.

12. The non-transitory machine-readable storage medium of claim 10, wherein the compression ratio is a ratio between an uncompressed file size of the captured screenshots and a reduced file size of the compressed screenshots.

13. The non-transitory machine-readable storage medium of claim 10, wherein the adjusting of the rate of screenshot capture comprises decreasing the rate of screenshot capture in reference to the compression ratio exceeding a threshold level.

14. The non-transitory machine-readable storage medium of claim 10, wherein the compression ratio identifies a type of display included in the captured screenshots.

15. The non-transitory machine-readable storage medium of claim 14, wherein the type of display includes a graphical display.

16. The non-transitory machine-readable storage medium of claim 14, wherein the type of display includes a text display.

17. The non-transitory machine-readable storage medium of claim 10, wherein the adjusting of the rate of screenshot capture comprises increasing the rate of screenshot capture in reference to the compression ratio falling below a threshold level.

18. A computing device comprising:
at least one processor; and
a memory in communication with the at least one processor, the memory being configured to store a screen sharing module, a coder-decoder module, and a processor monitoring module that are executable by the at least one processor,
the processor monitoring module having instructions, that when executed by the at least one processor cause operations to be performed, comprising monitoring a workload of the at least one processor,
the coder-decoder module having instructions, that when executed by the at least one processor cause operations to be performed, comprising compressing a number of screenshots and identifying a compression ratio of the compressed screenshots, and
the screen sharing module having instructions, that when executed by the at least one processor, cause operations to be performed, comprising:
capturing the number of screenshots at the computing device within a time interval, the number of screenshots within the time interval being defined in reference to the usage based on the workload of the at least one processor and to the compression ratio, the reference to the compression ratio being a reference to a type of display being compressed; and
transmitting the captured screenshots to another computing device.

19. The computing device of claim 18, wherein the screen sharing module, when executed by the at least one processor, cause further operations to be performed, comprising increasing the number of screenshots captured within the time interval in reference to the usage based on the workload of the at least one processor exceeding a threshold level.

20. The computing device of claim 18, wherein the screen sharing module, when executed by the at least one processor, cause further operations to be performed, comprising decreasing the number of screenshots captured within the time interval in reference to the usage based on the workload of the at least one processor falling below a threshold level.

21. (canceled)

22. The computing device of claim 18, wherein the at least one processor is a central processing unit.

23. The computing device of claim 18, wherein the at least one processor is a graphics processing unit.

24. A computing device comprising:
at least one processor; and
a memory in communication with the at least one processor, the memory being configured to store a screen sharing module that is executable by the at least one processor, the screen sharing module having instructions, that when executed by the at least one processor, cause operations to be performed, comprising:
capturing screenshots at the computing device;
compressing the captured screenshots;
identifying a compression ratio of the compressed screenshots;
monitoring a workload of the processor of the first computing device; and
adjusting a rate of screenshot capture at the computing device based on the workload of the processor and the compression ratio, the rate of screenshot capture defining a number of the screenshots captured within a time interval, the adjustment in reference to the compression ratio being an adjustment in reference to a type of display being compressed; and
transmitting the compressed screenshots to another computing device.
